(19) United States
(12) Patent Application Publication
(10) Pub. No.: US 2007/0281121 A1
(43) Pub. Date: Dec. 6, 2007

(54) Multiple component barriers

(76) Inventor: John Alan Petroski, Ravenna, OH (US)

Correspondence Address: FAY SHARPE LLP, 1100 SUPERIOR AVENUE, SEVENTH FLOOR, CLEVELAND, OH, 44114, US

(21) Appl. No.: 11/796,396

(22) Filed: Apr. 27, 2007

Related U.S. Application Data
(60) Provisional application No. 60/796,233, filed on Apr. 28, 2006.

(51) Int. Cl. B32B 33/00

(52) U.S. Cl. 428/40.1; 428/41.7

(57) ABSTRACT

A stackable sheet including a first side; a second side opposite the first side; a release coating applied to the first side; an adhesive applied to the second side; wherein the release coating is applied in a first pattern onto the first side, and the adhesive is applied to the second side in a second pattern substantially the same as the first pattern.

This application claims priority from Provisional Application No. 60/796,233, filed on Apr. 28, 2006, which is hereby incorporated by reference.

### BACKGROUND

It is often advantageous to create constructions with multiple layers of sheets or attachments. A common method for attachment of layers together is the use of adhesives, such as pressure sensitive adhesives (PSAs). PSAs, in particular, usually require some type of release coating on the side opposite the adhesive in order to allow parts to be stackable. Another option of providing parts is to have the adhesive of each part covered with a protective release liner.

The release coatings are typically formulated to prevent items from adhering to them. As a result, attaching materials to the release coating treated side of a stackable part becomes extremely difficult.

There are three possible ways to attach an item to a non-release coated. substrate, such as a plastic film. The object can be bonded to the film using an adhesive. The adhesive can be any suitable adhesive, such as a PSA, contact adhesive, heat sealable adhesive, hot applied adhesive, liquid applied adhesive, etc. Fusing the object to the plastic film/foam may also be considered if both materials are capable of being joined by ultrasonic welding, heat staking or thermal welding. Mechanical fasteners are another option, but pose the risk of penetrating the plastic film creating a point of intrusion for air, dust or water. The first two methods are severely limited if release coatings are present.

Release coatings may be based on silicone chemistry, or to a much lesser degree, non-silicones. They are typically supplied in rolls, but could also be provided in sheet form. Roll or web manufacturing is very advantageous in the economics of production of release coating. Release coatings are usually applied across the entire web width and dried/cured at very high speeds. When a roll pattern coating is required, it is usually limited to patterns running in the web machine direction. Because uncoated areas are usually in stripes or rows, they restrict the areas where attachments can be made.

Thus, there is a need to provide a means for attaching stackable materials while overcoming the above-mentioned difficulties and others.

### SUMMARY OF THE INVENTION

The present invention relates to multiple component barriers. More particularly, it relates to an assembly of sheets having adhesives and release coatings on opposite sides which have substantially the same pattern.

In accordance with one aspect of the invention, a stackable sheet includes a first side; a second side opposite the first side; a release coating applied to the first side; an adhesive applied to the second side; wherein the release coating is applied in a first pattern onto the first side, and the adhesive is applied to the second side in a second pattern substantially the same as the first pattern.

In accordance with another aspect of the invention, a plurality of stackable sheets includes a first sheet having an adhesive layer on a surface thereof; a second sheet having a release coating layer on a surface thereof; wherein the adhesive and the release coating are applied in substantially the same pattern, wherein the first sheet is positioned onto the second sheet thus aligning the adhesive layer with the release coating layer.

In accordance with still another aspect of the invention, an assembly of sheets has a first sheet, a second sheet, an adhesive layer formed on one of the sheets adjacent an opening of the sheet, and a fastening component extending through the opening of the sheet and penetrating the adhesive layer and connecting the first sheet to the second sheet.

Still other aspects of the invention will become apparent upon a reading of the following detailed description.

### DESCRIPTION OF THE DRAWINGS

Further aspects of the invention will become apparent by reference to the detailed description when considered in conjunction with the Figures, wherein like reference numbers indicate like elements through the several views, and wherein:

FIG. 1A is a plan view of an adhesive layer positioned over a release coating in accordance with one aspect of the invention;

FIG. 1B is a perspective view of the adhesive layer being positioned over the release coating;

FIG. 1C is a cross-sectional side-elevational view of the adhesive layer and release coating in an assembled configuration;

FIG. 1D is a cross-sectional side-elevational view of multiple release coatings and adhesive layers assembled to pads or sheets;

FIG. 2A is a plan view of a sound absorption sheet mounted over an automotive water deflector sheet using mechanical fasteners in accordance with another embodiment of the invention;

FIG. 2B is a side-elevational view in cross-section of the sound absorber of FIG. 2A installed over the watershield using a mechanical fastener and an adhesive material;

FIG. 2C illustrates a male fastener compressing the adhesive material of FIG. 2B; and

FIG. 2D illustrates the sound absorber and watershield of FIG. 2B in an assembled configuration.

### DETAILED DESCRIPTION OF THE EMBODIMENTS

The present invention relates to multiple component barriers. More particularly, it relates to an assembly of sheets having adhesives and release coatings on opposite sides which have substantially the same pattern. To overcome the problem of release coating being located on an area of the sheet where the coating would interfere with the placing of attachments, the release coating is preferably printed in precise complex patterns that match adhesive placement of stackable parts. The typical method would be a pattern gravure roll application, though other pattern application techniques such as screen printing or stenciling may also be employed without departing from the scope of the invention.

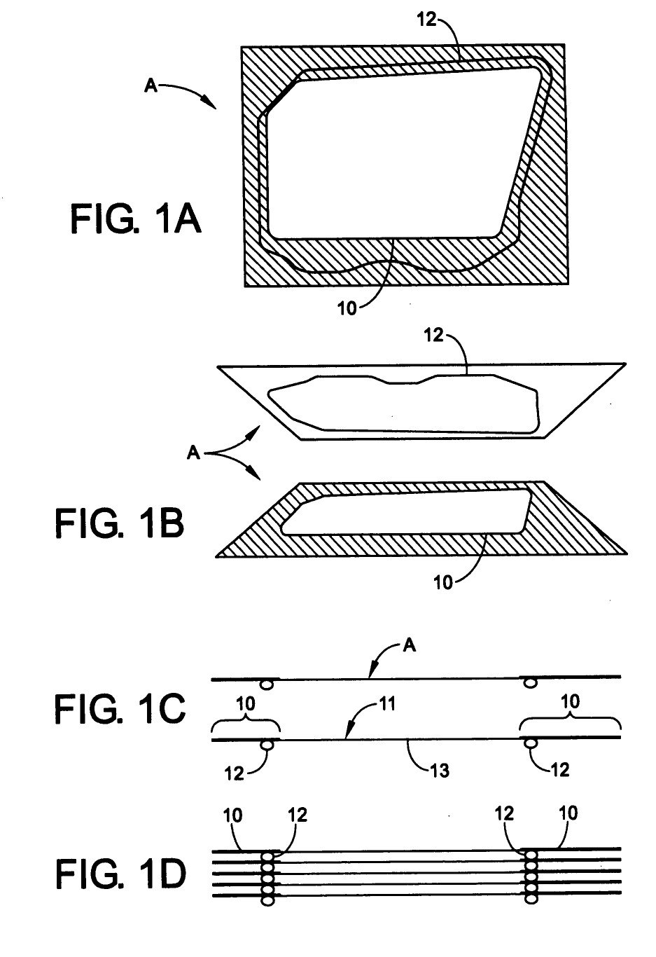

Referring now to FIG. 1A, in accordance with one embodiment of the invention, a release coating 10 is printed onto the backside of a facestock or sheet A that will receive an adhesive 12 on its front side. The release coating pattern substantially mirrors the placement of the adhesive pattern so that the release coating of the bottom stacked sheet matches the placement of the adhesive on the sheet stacked above the bottom sheet. This allows areas of non-release coated facestock or sheet on the backside of the sheet, which can be used to attach an object to the sheet using adhesives or thermal welding as methods of attachment.

Referring still to FIG. 1A, a pattern release coating 10 is shown as the darkened area, with the adhesive bead or pattern 12 being positioned over the release coated patterns 10. While FIG. 1A shows an adhesive bead, other adhesive forms can also be applied by methods including but not limited to spray, roll, manual, screen, stencil or flexographic printed application.

FIG. 1 B illustrates how the sheets A can be actually assembled. Each sheet A has a pattern release coating 10 on a first side 11 and an adhesive 12 applied to the opposite second side 13. Parts or sheets may then be stacked by placing the adhesive side 12 of side 13 of one sheet in alignment with and on top of the release coating 10 of side 11 of the next adjacent sheet below.

FIGS. 1C and 1D show cross-sectional views of the stacked relationship of the adhesive and release coating placement. In these illustrations, the release coating 10 extends to the edge or periphery of the sheet; but in practice, the pattern can be much more concise, being only directly under or next to the adhesive layer.

The release coating may also have a compatible dye, pigment or colorant incorporated into the release coating to provide a visual reference for the user during stacking. This would allow positive placement of the adhesive on top of the pattern release coated areas. Where items may be images of a left and right side, one color could be used to identify one side while a different color could be used to identify parts for the opposite side or pattern.

The adhesive used can be a pressure-sensitive adhesive (PSA), however, it would be equally advantageous when used with other forms of adhesive or thermal fusing techniques.

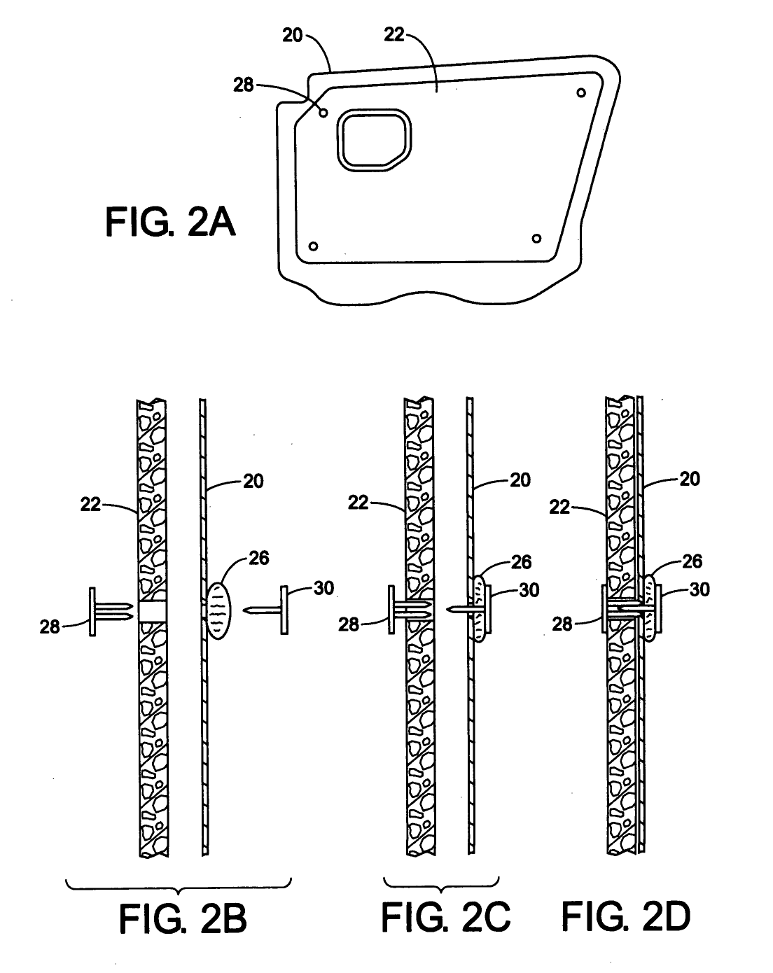

Another embodiment of the invention is shown in FIGS. 2A-2D. Mechanical fasteners may be an alternate approach to attach objects to the release coated side of a sheet or object. A method of employing mechanical fasteners includes applying an adhesive or gasketing material on the adhesive side of the film or sheet at the points where fasteners would penetrate the film or sheet. The adhesive or gasketing material would provide a positive seal between the fastener head and the film or sheet.

FIG. 2A illustrates an example of how a material could be placed over a sheet such as an automotive door water deflector 20 and a sound absorber 22. However, the mechanical fastener and adhesive arrangement could be used in any instance where a positive seal is required without departing from the scope of the invention. Polyolefin materials can be used for the water deflector and sound absorber. A wide range of materials not limited to papers, plastic films, foams, non-wovens, and composites may be used for either layer. In some instances, it may be advantageous to utilize more than two layers of materials.

Referring now to FIG. 2B, the placement of adhesive or gasket material 26 is illustrated along with the male/female components 28, 30 of a mechanical fastener. In this case, a perforation or opening 32 is placed in at least one of the polyolefin layers, but a non-perforated layer may be used where the male side of the fastener would self-penetrate the layer.

Referring to FIG. 2C, the male fastener 28 compresses the applied adhesive/gasket material 26 to provide a positive seal between the sheets. Referring to FIG. 2D, the completed sealed attachment with the male and female sides of the fastener securely locked in place is shown.

Another approach for a mechanical fastener is to employ a soft, compressible material within the fastener to act as a gasket or seal. This preformed seal would be an integral part of the fastener at the time of manufacture. However, due to the cost and complexity of this approach, an on-site applied adhesive/gasket material may offer significant advantage in time and cost reduction.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A stackable sheet, comprising:
a first side;
a second side opposite said first side;
a release coating applied to said first side;
an adhesive applied to said second side;
wherein said release coating is applied in a first pattern onto said first side, and said adhesive is applied to said second side in a second pattern substantially the same as said first pattern.

2. The sheet of claim 1, wherein said release coating of a first stackable sheet covers an adhesive of a second stackable sheet placed adjacent said first stackable sheet.

3. The sheet of claim 1, wherein said adhesive is applied as a bead onto said second side.

4. The sheet of claim 1, wherein said adhesive is sprayed onto said second side.

5. The sheet of claim 1, wherein said adhesive is stenciled onto said second side.

6. The sheet of claim 1, wherein said adhesive is a pressure-sensitive adhesive.

7. The sheet of claim 1, wherein said release coating is a silicone coating.

8. The sheet of claim 1, wherein said release coating is applied to the first side by rolling the coating onto the first side.

9. The sheet of claim 1, wherein said release coating comprises a colorant to aid in placement of an adhesive onto the release coating.

10. A plurality of stackable sheets, comprising:
a first sheet having an adhesive layer on a surface thereof;
a second sheet having a release coating layer on a surface thereof;
wherein said adhesive and said release coating are applied in substantially the same pattern,
wherein said first sheet is positioned onto said second sheet thus aligning said adhesive layer with said release coating layer.

11. A assembly of sheets comprising:
a first sheet;
a second sheet;
an adhesive layer formed on one of said sheets adjacent an opening of said one of said sheets;
and a fastening component extending through said opening of one of said sheets and penetrating said adhesive layer and connecting said first sheet to said second sheet.

12. The assembly of sheets of claim 11, wherein said adhesive provides a positive seal between said fastening component and second sheets.

13. The assembly of claim 11, wherein said first sheet and said second sheet are formed of polyolefin material.

14. The assembly of claim 11, wherein said fastening component comprises a male fastener and a female fastener.

15. The assembly of claim 11, wherein said fastening component comprises a compressible material.
